(19) United States
(12) Patent Application Publication
(10) Pub. No.: US 2009/0178032 A1
(43) Pub. Date: Jul. 9, 2009

(54) Mining for performance data for systems with dynamic compilers

(76) Inventors: Rongzhen Yang, Shanghai (CN); Feng Chen, Shanghai (CN)

Correspondence Address: INTEL CORPORATION;c/o CPA Global, P.O. BOX 52050, MINNEAPOLIS, MN, 55402, US

(21) Appl. No.: 10/585,292

(22) PCT Filed: Mar. 3, 2005
(86) PCT No.: PCT/CN05/00258

§ 371 Date: Jul. 5, 2006

(51) Int. Cl. G06F 9/45

(52) U.S. Cl. 717/151; 717/130

(57) ABSTRACT

In an example data mining process, performance data for instructions that execute in a data processing system is obtained. The performance data may comprise instruction addresses and corresponding performance information. A dump that comprises the instructions and corresponding instruction addresses may also be obtained. Common code segments in the dump may be automatically identified. A common code segment may comprise an ordered set of multiple instructions that appears multiple times in the dump. Aggregate performance data for the common code segments may be generated, based at least in part on (a) the instruction addresses associated with the common code segments in the dump, and (b) the instruction addresses and the corresponding performance information from the performance data. Other embodiments are described and claimed.

### FIELD OF THE INVENTION

The present disclosure relates generally to the field of data processing, and more particularly to methods and apparatuses for processing information pertaining to software performance.

### BACKGROUND

A conventional static compiler accepts source code (e.g., a computer program written in a high level programming language such as C, or in assembly language) and generates object code for a particular operating system (OS) or platform. In years past, most software applications were written in a high level language, and then a static compiler was used to compile the source code into object code for the target platform. The object code was then executed by a data processing system to provide the application's functionality for the end user. However, object code that is generated for one OS generally will not run on other OSs.

In recent years, managed runtime environments (MRTEs), such as the .NET platform from Microsoft Corporation and the Java platform from Sun Microsystems, Inc., have become increasingly prevalent. An MRTE is a platform or environment that runs in a processing system on top of the hardware and OS, to provide a layer of abstraction so that applications to execute on top of the MRTE do not need to address or cope with the specifics of the OS and hardware of the underlying processing system. MRTEs are also sometimes referred to as virtual machines (VMs) or dynamic runtime environments. MRTEs may handle tasks such as heap management, security, class loading, garbage collection, and memory allocation, for example.

In effect, instead of writing and compiling code for a particular OS and hardware architecture, developers can write code for an MRTE. That code may then execute on top of any OS that is supported by the MRTE. In particular, once a programmer has developed code for a selected virtual machine, the programmer may use a static compiler to generate intermediate language (IL) code to run on that virtual machine. For instance, if source code written in the Java programming language is compiled for a JVM, the compiler produces IL code know as byte code. When it is time to run the application, the JVM may dynamically interpret and/or compile the byte code, to facilitate execution of the application in the given hardware and OS environment.

Similarly, an MRTE such as the IA-32 Execution Layer (EL) from Intel Corporation may be used to provide a layer of abstraction on top of a new platform, so that code written or compiled for an older platform can execute on the new platform with few, if any, changes. An MRTE may thus facilitate migration of an application to a new platform, even though the application's object code may have been compiled for a different platform, and even though the application may not have be designed to address or cope with the specifics of the OS and/or hardware of the new platform. Accordingly, for purposes of this disclosure, when object code that was compiled for one OS or hardware architecture executes on top of an MRTE in a processing system with a different OS or hardware architecture, that object code is considered IL code.

For purposes of this disclosure, a dynamic compiler is a compiler that executes on a processing system in association with an MRTE, accepts IL code as input, and generates output that includes object code which can execute within the context of the OS for that processing system. Unlike static compilers, which typically compile an entire program before any part of the program can start to execute, dynamic compilers typically compile IL code on the fly. That is, dynamic compilers typically compile portions of the IL code for a program as those portions are needed, while other portions of the program may have already executed. Accordingly, dynamic compilers may also be referred to as just-in-time (JIT) compilers.

When a computer program is compiled with a conventional static compiler, it typically is not difficult to analyze the performance of that program using conventional performance monitoring tools, such as the Intel® VTune™ Performance Analyzers, which are distributed by Intel Corporation. The performance analysis results for a statically compiled program may then be used to determine which portions of the program have the most significant impact on performance, so that efforts to tune the program for increased performance may be focused accordingly. However, when software is dynamically compiled, the performance analysis results may not include all of the information necessary to determine which portions of the source code or IL code have the most significant impact on performance.

### BRIEF DESCRIPTION OF THE DRAWINGS

The features and advantages of the present invention will become apparent from the appended claims and the following detailed description and drawings for one or more example embodiments, in which:

FIG. 1 is a block diagram depicting hardware and software in a suitable data processing environment to provide mining for performance data, in accordance with an example embodiment of the present invention; and

FIG. 2 is a block diagram depicting example embodiments of dynamic code to be parsed according to absolute matching and corresponding results, in accordance with an example embodiment of the present invention;

FIG. 3 is a block diagram depicting example embodiments of dynamic code to be parsed according to code template matching and corresponding results, in accordance with an example embodiment of the present invention;

FIG. 4 provides a flowchart of a process for mining code segment performance information, in accordance with an example embodiment of the present invention;

FIG. 5 provides a flowchart of a process to expand upon the operation in FIG. 4 of identifying common code segments, in accordance with an example embodiment of the present invention; and

FIG. 6 is a block diagram that includes example inputs and outputs for an example process for mining code segment performance information, in accordance with an example embodiment of the present invention.

### DETAILED DESCRIPTION

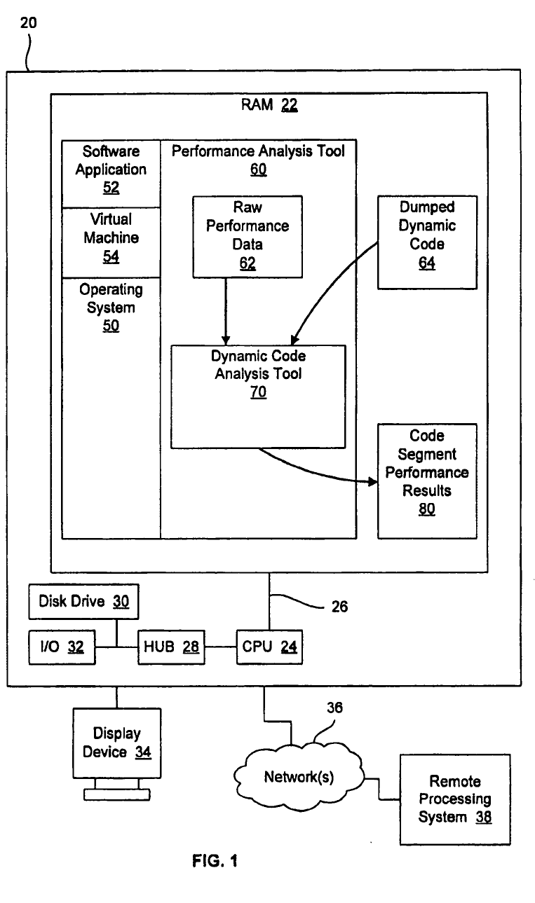

FIG. 1 is a block diagram depicting example hardware and software components in an example data processing environment to provide mining for performance data, in accordance with an example embodiment of the present invention. FIG. 1 and the following discussion are intended to provide a general description of a suitable environment in which certain aspects of the present invention may be implemented. As used herein, the terms “processing system” and “data processing system” are intended to broadly encompass a single machine, or a system of communicatively coupled machines or devices operating together. Exemplary processing systems include, without limitation, distributed computing systems, supercomputers, computing clusters, mainframe computers, mini-computers, client-server systems, personal computers, workstations, servers, portable computers, laptop computers, tablet processing systems, telephones, personal digital assistants (PDAs), handheld devices, mobile handsets, entertainment devices such as audio and/or video devices, and other devices for processing or transmitting information.

The data processing environment of FIG. 1 may include a processing system 20 that includes one or more processors or central processing units (CPUs) 24 communicatively coupled to various other components via one or more buses or other communication conduits or pathways. Processor 24 may be implemented as an integrated circuit (IC) with one or more processing cores. The components coupled to processor 24 may include one or more volatile or non-volatile data storage devices, such as random access memory (RAM) 22 and read-only memory (ROM). One or more buses 26 may serve to couple RAM 22 and ROM with processor 24, possibly via one or more intermediate components, such as a hub 28, a memory controller, a bus bridge, etc. For purposes of this disclosure, the term “ROM” refers in general to non-volatile memory devices such as erasable programmable ROM (EPROM), electrically erasable programmable ROM (EEPROM), flash ROM, flash memory, non-volatile RAM (NV-RAM), etc.

Processor 24 may also be communicatively coupled to mass storage devices, such as one or more integrated drive electronics (IDE) drives, small computer systems interface (SCSI) drives, or other types of hard disk drives 30. Other types of mass storage devices and storage media that may be used by processing system 20 may include floppy-disks, optical storage, tapes, memory sticks, digital video disks, polymer storage, biological storage, etc.

Additional components may be communicatively coupled to processor 24 in processing system 20, including, for example one or more of each of the following: video, SCSI, network, universal serial bus (USB), and keyboard controllers; other types of device or input/output (I/O) controllers 32; network ports; other I/O ports; I/O devices; etc. Such components may be connected directly or indirectly to processor 24, for example via one or more buses and bus bridges. In some embodiments, one or more components of processing system 20 may be implemented as embedded devices, using components such as programmable or non-programmable logic devices or arrays, application-specific integrated circuits (ASICs), smart cards, etc.

Processing system 20 may be controlled, at least in part, by input from conventional input devices, such as a keyboard or keypad, a pointing device, etc., and/or by directives received from one or more remote data processing systems 38, interaction with a virtual reality environment, biometric feedback, or other input sources or signals. Processing system 20 may send output to components such as a display device 34, remote data processing system 38, etc. Communications with remote data processing system 38 may travel through any suitable communications medium. For example, processing systems 20 and 38 may be interconnected by way of one or more physical or logical networks 36, such as a local area network (LAN), a wide area network (WAN), an intranet, the Internet, a public switched telephone network (PSTN), a cellular telephone network, etc. Communications involving network 36 may utilize various wired and/or wireless short range or long range carriers and protocols, including radio frequency (RF), satellite, microwave, Institute of Electrical and Electronics Engineers (IEEE) 802.11, Bluetooth, optical, infrared, cable, laser, etc.

The invention may be described by reference to or in conjunction with associated data including instructions, functions, procedures, data structures, application programs, etc. which, when accessed by a machine, result in the machine performing tasks or defining abstract data types or low-level hardware contexts. Such data may be referred to in general as software, and it may be stored in volatile and/or non-volatile data storage.

For example, one or more storage devices accessible to or residing within processing system 20, such as disk drive 30, may include some or all of an OS 50 to be loaded into RAM 22 when processing system 20 is powered up, for example as part of a boot process. Disk drive 30 may also include one or more software applications 52 to be loaded into RAM 22, as well as an MRTE or virtual machine 54 to be loaded into RAM 22 and to execute substantially between software application 52 and OS 50.

In addition, disk drive 30 may include a dynamic code analysis tool 70 within a performance analysis tool 60. In alternative embodiments, dynamic code analysis tool 70 may be implemented completely or partially outside of performance analysis tool 60. As described in greater detail below, dynamic code analysis tool 70 may obtain raw performance data 62 from performance analysis tool 60, and may use that data to generate performance information 80 pertaining to software components that have been dynamically compiled by VM 54 and then executed in processing system 20. Also, dynamic code analysis tool 70 may obtain a dump 64 of the code that was dynamically compiled, and may use information from the dump when generating performance data 80. Performance data 80 may help software developers or tuners to optimize the performance of the software under evaluation, by helping them to find performance hot spots in dynamically compiled code. For purposes of this disclosure, the terms “dynamically compiled code” and “dynamic code” refer to the object code that is generated as the result of dynamic compilation. Dynamically compiled code may also be referred to as just-in-time (JIT) code.

Dumps typically include a listing of some or all of the instructions that have been executed by a computer, and dumps are typically generated from a computer's main memory, such as RAM 22. For purposes of this disclosure, the term “dump” includes data obtained from a computer's main memory or any similar location, and a dump need not include all of the data from the main memory, but may only include a subset of that data. Furthermore, information is considered as coming from the dump if the information originated in the dump, even if the data is moved to another data construct or storage location before processing of the data is complete.

In the example embodiment, the IL code for software application 52 may include multiple individual programs or modules, and each of those programs or modules may include subcomponents, such as methods or functions for example. Dynamic compilers typically use code templates to generate code segments in the object code corresponding to the IL code being compiled. For example, when compiling a method entry, a dynamic compiler may use a code template to generate a code segment to serve as the initial block of code in the object code for that method. The same code template may be used to generate the initial block of code for other methods, as well. Consequently, the same or similar code segments may appear in the initial block of code for many different methods. Similarly, the dynamic compiler may use other code templates for compiling other types of operations or constructs in the IL code, thereby populating the object code with the code segments based on those code templates.

It would be difficult for a person to evaluate the performance of each of those code templates using only conventional performance analysis tools. For instance, conventional performance analysis tools may provide relative performance results for individual methods, but not for individual code segments as such. A method may include thousands of object code instructions, and those instructions may have been generated from many different code templates. In addition, the same code template may be used to generate code segments for many different methods. Therefore, the conventional performance results may not provide the information needed to identify hot code templates. A hot code template is a code template which generates code segments that, in the aggregate, consume a relatively large amount of execution time.

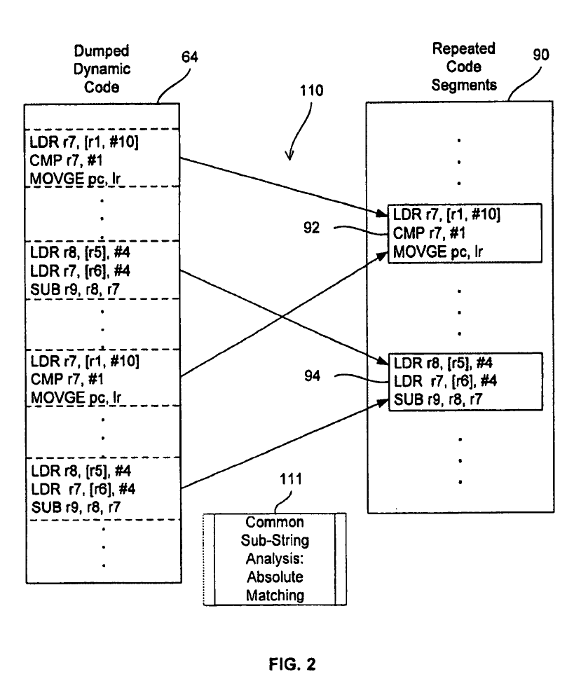

FIG. 2 is a block diagram depicting example embodiments of dynamic code to be parsed and corresponding results, in accordance with an example embodiment of the present invention. In particular, in the example embodiment, dynamic code analysis tool 70 parses dump 64 to identify code segments such as those inserted by the dynamic compiler based on code templates. As described in greater detail below, dynamic code analysis tool 70 then uses raw performance data 62 to determine performance results 80 for the identified code segments.

In the example embodiment, dump 64 contains the object code that was produced by the dynamic compiler for application 52. As indicated by operation block 111, dynamic code analysis tool 70 uses a technique known as common substring analysis to identify code segments that appear multiple times in dump 64. In particular, the type of common substring analysis illustrated in FIG. 2 is called absolute matching. According to that type of analysis, code segments at different locations within dump 64 are determined to match if those code segments are identical or substantially identical, as indicated by arrows 110. The result of the common substring analysis is a list or table 90 of the repeated or common code segments, such as code segments 92 and 94.

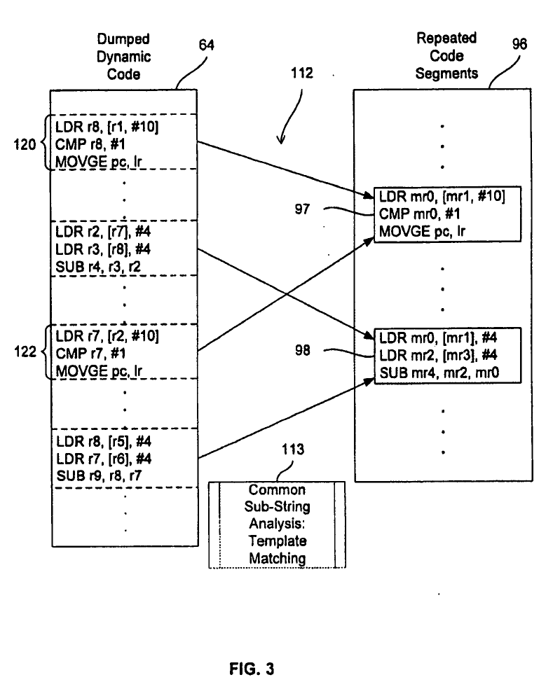

FIG. 3 is a block diagram depicting example embodiments of dynamic code to be parsed and corresponding results, in accordance with an example embodiment of the present invention. As with FIG. 2, dynamic code analysis tool 70 parses dump 64 and generates a list 96 of common code segments, such as code segments 97 and 98. However, as indicated by operation block 113, the parsing technique illustrated in FIG. 3 is called code template matching. According to that technique, code segments from different locations in dump 64 are considered matches if certain significant elements in those code segments match, as indicated by arrows 112.

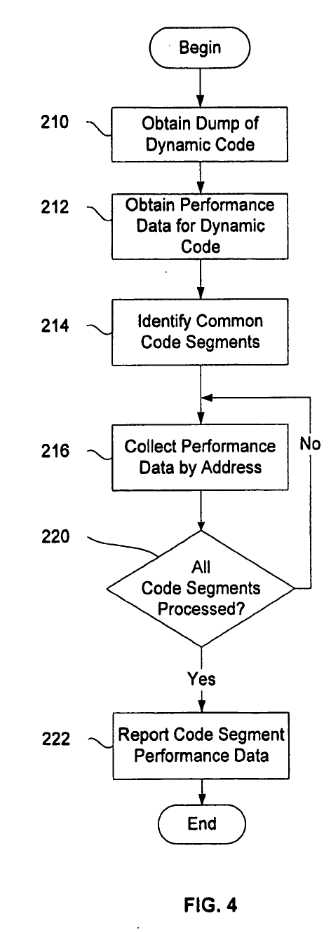

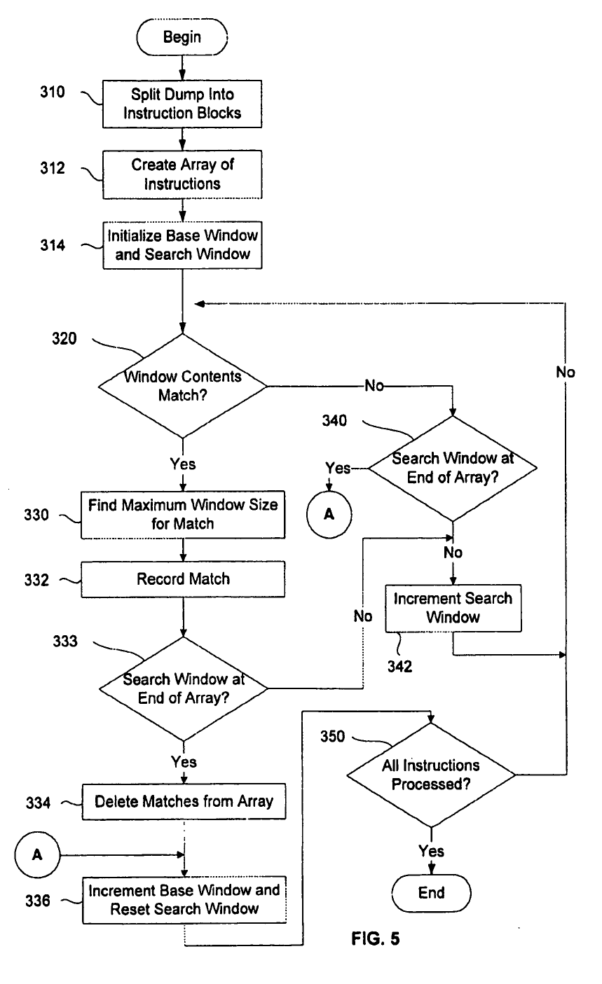

Code segments that have been determined to match according to either of the above techniques, or any similar technique, may be referred to as common code segments. Additional details regarding an example process for identifying common code segments are provided below with regard to FIGS. 4 and 5.

FIG. 4 provides a flowchart of an overall process for mining performance data for code segment performance information, in accordance with an example embodiment of the present invention. The illustrated process may begin immediately or promptly after software application 52 has executed on top of virtual machine 54. Then, as depicted at blocks 210 and 212, dynamic code analysis tool 70 may obtain dump 64 from virtual machine 54 or OS 50, and may obtain raw performance data 62 from performance analysis tool 60. As depicted at block 214, dynamic code analysis tool 70 may then identify repeated or common code segments within dump 64. Examples of such operations were referenced above, and examples are described in greater detail below in connection with FIG. 5.

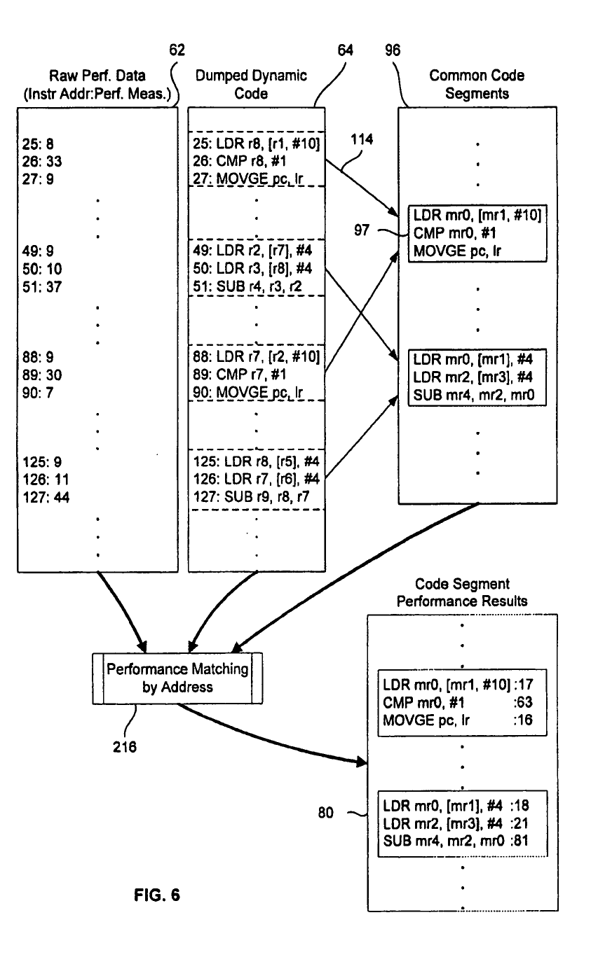

As illustrated at block 216 and described in greater detail below in connection with FIG. 6, dynamic code analysis tool 70 may then use raw performance data 62 to generate performance measurements for some or all of the common code segments. At block 220 dynamic code analysis tool 70 may determine whether performance data has been generated for all of the common code segments. If dynamic code analysis tool 70 has not yet generated performance data for all of the common code segments, the process may return to block 216, with dynamic code analysis tool 70 collecting performance data for the next common code segment. Once all common code segments have been processed, dynamic code analysis tool 70 may report performance results 80, as indicated at block 222.

FIG. 5 provides a flowchart of an example process to expand upon the operation of identifying common code segments depicted at block 214 of FIG. 4. After completing the operation depicted at block 212 of FIG. 4, dynamic code analysis tool 70 may begin the process of identifying repeated or common code segments by splitting dump 64 into instruction blocks, as indicated at block 310 of FIG. 5. As indicated at block 312, each instruction from dump 64, or from the relevant portion of dump 64, may then be loaded into an array, or any other suitable data construct, for additional processing. The relevant portion of the dump may be identified manually or automatically, for instance through use of a program that trims the dump in accordance with rules for a particular type of virtual machine. Since the instructions in the array are obtained from dump 64, those instructions may be referred to as dump information.

At block 314, dynamic code analysis tool 70 may initialize a base window and a search window to be used for locating common code segments. In the example embodiment, dynamic code analysis tool 70 uses a predetermined minimum significant segment size, such as two instructions for instance, to define the initial size of the base and search windows. In alternative embodiments, dynamic code analysis tool 70 may use larger minimum window sizes or thresholds. In the example embodiment, dynamic code analysis tool 70 sets the base and search windows to the same size, starts the base window at the beginning of the set of relevant instructions, and starts the search window at the instruction following the last instruction covered by the base window. As described below, dynamic code analysis tool 70 may then use the base window to select a candidate code segment from the dump, and may use the search window to determine whether the dump includes at least one additional match for the candidate code segment.

For instance, at block 320, dynamic code analysis tool 70 may determine whether the contents of the base window and the search window match. As described above with regard to FIGS. 2 and 3, dynamic code analysis tool 70 may use any suitable technique for determining whether the contents of the windows match, including absolute matching and code template matching. For instance, if dynamic code analysis tool 70 is set to use code template matching, before comparing the contents of the windows, dynamic code analysis tool 70 may determine which elements of the instructions in those windows are significant. Dynamic code analysis tool 70 may then determine whether the contents match based on a comparison of the elements identified as significant.

For example, referring again to FIG. 3, when the base window reaches position 120, dynamic code analysis tool 70 may determine which elements within each of the instructions in that particular code segment are significant, and may generate a code template to represent the significant elements. For instance, as illustrated at code segment 97, the code template may specify a load register (LDR) instruction, followed by a compare (CMP) instruction, followed by a move if greater or equal (MOVGE) instruction. In addition, the code template may include abstracted elements in place of less significant elements from the dumped code. For instance, for all instructions in a particular code segment, dynamic code analysis tool 70 may replace all references to particular registers (such as “r8,” “r1,” etc.) with respective generic register identifiers (such as “mr0,” ‘mr1,” etc.). Similarly, when the search window reaches position 122, for example, dynamic code analysis tool 70 may use the same types of abstractions to generate a code template for the code segment within the search window. Dynamic code analysis tool 70 may then determine whether the window contents match by comparing the base window code template and search window code template.

In an example embodiment, dynamic code analysis tool 70 may use predetermined normalization rules to determine which elements should be abstracted and how those elements are to be abstracted. Dynamic code analysis tool 70 may accept those rules as input. Accordingly, the normalization rules may easily be changed as appropriate for analyzing any particular software application.

Referring again to block 320 of FIG. 5, if dynamic code analysis tool 70 determines that the contents do not match, dynamic code analysis tool 70 may determine whether the search window has reached the last instruction, as depicted at block 340. If the last instructions has not been reached, dynamic code analysis tool 70 may increment the search window one instruction, as indicated at block 342, and the process may return to block 320 to determine whether the new contents of the search window match the contents of the base window. However, if the search window has reached the last instruction, the process may pass to block 336, which depicts dynamic code analysis tool 70 incrementing the base window and resetting the search window, as described below.

When dynamic code analysis tool 70 determines at block 320 that the window contents match, dynamic code analysis tool 70 may find the maximum window size for the match, as indicated at block 330. For instance, dynamic code analysis tool 70 may adjust the beginning and the end of the base window and the beginning and the end of the search window, and may conduct additional comparisons to determine whether the number of instructions that match is larger than the minimum window size. Once the maximum window size for the match has been found, dynamic code analysis tool 70 records the match, as indicated at block 332. For instance, dynamic code analysis tool 70 may add the common code segment to a file or table, such as list 90 or list 96, as depicted in FIGS. 2 and 3.

Dynamic code analysis tool 70 may then determine whether all instructions have been searched for a match with the base window, as depicted at block 333. If the search window has reached the end if the array of instructions, dynamic code analysis tool 70 may then remove all occurrences of the common code segment from the array or list of instructions, as indicated at block 334. At block 336 dynamic code analysis tool 70 may increment the base window one instruction and reset the search window to prepare to search for the next common code segment. As depicted at block 350, if dynamic code analysis tool 70 determines that the base window has already covered all of the instructions, or enough of the instructions to indicate that no further matches can be found, the process of FIG. 5 may end, with operations resuming at block 216 of FIG. 4. However, if additional instructions remain to be analyzed, the process my return to block 320 from block 350, with dynamic code analysis tool 70 determining whether the contents of the windows match, as described above.

However, referring again to block 333, if the search window has not reached the end of the array, dynamic code analysis tool 70 may increment the search window as indicated at block 342, and may continue to search for matches with the base window, as described above. Dynamic code analysis tool 70 may continue analyzing the instructions until all common code segment have been identified.

FIG. 6 is a block diagram that includes example inputs and outputs for an example process for mining performance data for code segment performance information, in accordance with an example embodiment of the present invention. As indicated in connection with process block 216, in the example embodiment, after compiling a list 96 of the common code segments, dynamic code analysis tool 70 may obtain performance information for those code segments from raw performance data 62. In particular, dynamic code analysis tool 70 may determine which addresses in dump 64 correspond to each code segment, and dynamic code analysis tool 70 may use those addresses to collect the relevant performance information from raw performance data 62.

For instance, by searching through dump 64, dynamic code analysis tool 70 may determine that the “LDR” instruction in common code segment 97 was executed from addresses 25 and 88. Dynamic code analysis tool 70 may therefore aggregate the performance information from raw performance data 62 for those two addresses to generate an aggregate performance result for that instruction in the context of common code segment 97. As illustrated in FIG. 6, the performance information or measurements associated with addresses 25 and 88 are 8 and 9, respectively. Accordingly, dynamic code analysis tool 70 may assign an aggregate performance result of 17 to that instruction in the context of common code segment 97. Dynamic code analysis tool 70 may perform similar operations with regard to the next two instructions within common code segment 97, to generate respective aggregate performance measurements of 63 and 16.

In addition, dynamic code analysis tool 70 may aggregate all of the aggregate performance measurements for each common code segment. For instance, dynamic code analysis tool 70 may generate a total aggregate performance measurement of 96 for common code segment 97, and may generate a total aggregate performance measurement of 120 for the other common code segment that is illustrated in common code segment list 96 in FIG. 6.

Thus, as has been described, dynamic code analysis tool 70 may obtain a dump that contains instructions and corresponding instruction addresses. Dynamic code analysis tool 70 may also obtain performance data for the instructions, and that performance data may include instruction addresses and corresponding performance information. Dynamic code analysis tool 70 may also automatically identify common code segments in the dump. Each common code segment may be an ordered set of instructions that appears multiple times in the dump. Dynamic code analysis tool 70 may then generate aggregate performance data for the common code segments, based at least in part on the instruction addresses associated with the common code segments from the dump, the instruction addresses from the performance data, and the corresponding performance information from the performance data.

In the example embodiment, raw performance data 62 includes a single measurement, such as execution time, for each instruction. In alternative embodiments, the raw performance data may include one or more different kinds of metrics, in conjunction with, or instead of, execution time. For instance, the raw performance data may include counts of instructions executed and cache miss data for individual instructions. In a system that uses Intel XScale® technology, the metrics may include cache event information, including metrics for the data cache and the instruction cache; translation lookaside buffer (TLB) event information, including metrics for data TLB and instruction TLB events; data dependency stall information; and branch-target buffer (BTB) event information, for example. In a system that uses Intel® Itanium® architecture, the metrics may include TLB event information; data dependency stall information; L1, L2, and L3 cache event information; and front side bus (FSB) event information, for example.

Once dynamic code analysis tool 70 had generated code segment performance results 80, those results may clearly indicate which common code segments have had the most impact on the performance of software application 52. For instance, dynamic code analysis tool 70 may compute a percentage measurement of the performance impact of each common code segment, based on the total aggregate performance result for each common code segment. Such an analysis may be used to produce output such as that illustrated below in Table 1.

TABLE 1
Example performance results

| Common Code Segment | Samples | Ratio |
|---|---|---|
| Method Head | 26991 | 20.83% |
| Null Pointer Check | 12908 | 9.96% |
| Array Boundary Check | 9822 | 7.58% |
| Method Return | 7502 | 5.79% |

In Table 1, the column “Common Code Segment” contains names for code segments that have been identified as occurring multiple times, as described above. The data in the “Samples” column reflects how often each code segment was executed. For instance, before starting the VM to be studied, an engineer may set performance analysis tool 60 to send a notification whenever a predetermined number of events of a particular type has transpired. For instance, performance analysis tool 60 may be set to send a notification whenever 100,000 events of the type “instruction executed” have transpired. Accordingly, the “Samples” value of 26,991 indicates that execution was found to be within the “Method Head” common code segment 26,991 times, out of all the times that performance analysis tool 60 sent the above notification. Similarly, the “Ratio” column indicates that execution was found to be within the “Method Head” common code segment 20.83% of the time that performance analysis tool 60 sent the above notification.

In one embodiment, dynamic code analysis tool 70 may give each common code template that it identifies an arbitrary name (e.g., template(1), template(2), etc.). A software tuner or developer may then determine which of the code templates that the dynamic complier uses corresponds to each common code segment, and may manually assign more meaningful names to the common code segments. Alternatively, the software tuner or developer may only consider and rename the common code segments of the greatest interest, such as the common code segments with the greatest performance impact. An individual involved with developing or tuning the dynamic compiler may then concentrate subsequent tuning efforts on the code templates with the most significant impact on performance.

In light of the principles and example embodiments described and illustrated herein, it will be recognized that the illustrated embodiments can be modified in arrangement and detail without departing from such principles. For instance, the present invention is not limited to utilization in the example embodiments described herein, but may also be used to advantage in many other types of systems. In addition, although the foregoing discussion has focused on particular embodiments, other configurations are contemplated. In particular, even though expressions such as “in one embodiment,” “in another embodiment,” or the like may appear herein, these phrases are meant to generally reference embodiment possibilities, and are not intended to limit the invention to particular embodiment configurations. As used herein, these terms may reference the same or different embodiments that are combinable into other embodiments.

Similarly, although example processes have been described with regard to particular operations performed in a particular sequence, it will be apparent to those of ordinary skill in the art that numerous modifications to the processes could be applied to derive numerous alternative embodiments of the present invention. For example, alternative embodiments may include processes that use fewer than all of the disclosed operations, processes that use additional operations, processes that use the same operations in a different sequence, and processes in which the individual operations disclosed herein are combined, subdivided, or otherwise altered. For example, although certain search techniques have been described above, alternative embodiments of the present invention may use other search techniques.

Alternative embodiments of the invention also include machine accessible media encoding instructions for performing the operations of the invention. Such embodiments may also be referred to as program products. Such machine accessible media may include, without limitation, storage media such as floppy disks, hard disks, CD-ROMs, DVDs, ROM, and RAM; as well as communications media such antennas, wires, optical fibers, microwaves, radio waves, and other electromagnetic or optical carriers. Accordingly, instructions and other data may be delivered over transmission environments or networks in the form of packets, serial data, parallel data, propagated signals, etc., and may be used in a distributed environment and stored locally and/or remotely for access by single or multi-processor machines.

It should also be understood that the hardware and software components depicted herein represent functional elements that are reasonably self-contained so that each can be designed, constructed, or updated substantially independently of the others. In alternative embodiments, many of the components may be implemented as hardware, software, or combinations of hardware and software for providing the functionality described and illustrated herein. The hardware, software, or combinations of hardware and software for performing the operations of the invention may also be referred to as logic or control logic.

In view of the wide variety of useful permutations that may be readily derived from the example embodiments described herein, this detailed description is intended to be illustrative only, and should not be taken as limiting the scope of the invention. What is claimed as the invention, therefore, are all implementations that come within the scope and spirit of the following claims and all equivalents to such implementations.

What is claimed is:

1. A method comprising:
obtaining performance data for software that has executed in a data processing system, wherein the performance data comprises instruction addresses and corresponding performance information;
obtaining dump information from the data processing system, wherein the dump information comprises the instructions and corresponding instruction addresses;
automatically identifying common code segments in the dump information, wherein a common code segment comprises an ordered set of multiple instructions that appears multiple times in the dump information; and
generating aggregate performance data for the common code segments, based at least in part on the instruction addresses associated with the common code segments from the dump information, the instruction addresses from the performance data, and the corresponding performance information from the performance data.

2. A method according to claim 1, wherein:
the operation of obtaining performance data comprises obtaining performance data for instructions generated by a dynamic compiler; and
the operation of generating aggregate performance data for the common code segments comprises generating aggregate performance data for common code segment generated by the dynamic compiler.

3. A method according to claim 1, wherein the operation of identifying common code segments in the dump information comprises:
selecting a candidate code segment from the dump information;
determining whether the candidate code segment occurs multiple times in the dump information; and
identifying the candidate code segment as a common code segment in response to determining that the candidate code segment occurs multiple times in the dump information.

4. A method according to claim 1, wherein the operation of identifying common code segments in the dump information comprises:
selecting a candidate code segment from the dump information;
determining whether the dump information includes at least one additional absolute match for the candidate code segment; and
identifying the candidate code segment as a common code segment in response to determining that the dump information includes at least one additional absolute match for the candidate code segment.

5. A method according to claim 1, wherein the operation of identifying common code segments in the dump information comprises:
selecting a candidate code segment from the dump information;
identifying elements in the candidate code segment as significant;
determining whether the dump information includes at least one additional match for the candidate code segment, wherein the additional match comprises instructions with elements matching the significant elements in the candidate code segment; and
identifying the candidate code segment as a common code segment in response to determining that the dump information includes at least one additional match for the candidate code segment.

6. A method according to claim 1, wherein the performance information comprises one or more measurements selected from the group consisting of:
execution time data for individual instructions; and
cache miss data for individual instructions.

7. A method according to claim 1, wherein:
the operation of identifying common code segments in the dump information comprises identifying at least first and second common code segments; and
the operation of generating aggregate performance data for the common code segments comprises:
collecting performance data for multiple instances of the first common code segment;
generating aggregate performance data for the first common code segment, based at least in part on the performance data for the multiple instances of the first common code segment;
collecting performance data for multiple instances of the second common code segment; and
generating aggregate performance data for the second common code segment, based at least in part on the performance data for the multiple instances of the second common code segment.

8. A method according to claim 7, wherein the operation of generating aggregate performance data for the common code segments comprises:
collecting performance information corresponding to instruction addresses for substantially all instances of the common code segment in the dump information.

9. An apparatus, comprising:
a machine accessible medium; and
software encoded in the machine accessible medium, wherein the software, when executed by a processing system, performs operations comprising:
obtaining performance data for software that has executed in a data processing system, wherein the performance data comprises instruction addresses and corresponding performance information;
obtaining dump information from the data processing system, wherein the dump information comprises the instructions and corresponding instruction addresses;
automatically identifying common code segments in the dump information, wherein a common code segment comprises an ordered set of multiple instructions that appears multiple times in the dump information; and
generating aggregate performance data for the common code segments, based at least in part on the instruction addresses associated with the common code segments from the dump information, the instruction addresses from the performance data, and the corresponding performance information from the performance data.

10. An apparatus according to claim 9, wherein:
the operation of obtaining performance data comprises obtaining performance data for instructions generated by a dynamic compiler; and
the operation of generating aggregate performance data for the common code segments comprises generating aggregate performance data for common code segment generated by the dynamic compiler.

11. An apparatus according to claim 9, wherein the operation of identifying common code segments in the dump information comprises:
selecting a candidate code segment from the dump information;
determining whether the candidate code segment occurs multiple times in the dump information; and
identifying the candidate code segment as a common code segment in response to determining that the candidate code segment occurs multiple times in the dump information.

12. An apparatus according to claim 9, wherein the operation of identifying common code segments in the dump information comprises:
selecting a candidate code segment from the dump information;
determining whether the dump information includes at least one additional absolute match for the candidate code segment; and
identifying the candidate code segment as a common code segment in response to determining that the dump information includes at least one additional absolute match for the candidate code segment.

13. An apparatus according to claim 9, wherein the operation of identifying common code segments in the dump information comprises:
selecting a candidate code segment from the dump information;
identifying elements in the candidate code segment as significant;
determining whether the dump information includes at least one additional match for the candidate code segment, wherein the additional match comprises instructions with elements matching the significant elements in the candidate code segment; and
identifying the candidate code segment as a common code segment in response to determining that the dump information includes at least one additional match for the candidate code segment.

14. An apparatus according to claim 9, wherein the performance information comprises one or more measurements selected from the group consisting of:
execution time data for individual instructions; and
cache miss data for individual instructions.

15. An apparatus according to claim 9, wherein:
the operation of identifying common code segments in the dump information comprises identifying at least first and second common code segments; and
the operation of generating aggregate performance data for the common code segments comprises:
collecting performance data for multiple instances of the first common code segment;
generating aggregate performance data for the first common code segment, based at least in part on the performance data for the multiple instances of the first common code segment;
collecting performance data for multiple instances of the second common code segment; and
generating aggregate performance data for the second common code segment, based at least in part on the performance data for the multiple instances of the second common code segment.

16. An apparatus according to claim 15, wherein the operation of generating aggregate performance data for the common code segments comprises:
collecting performance information corresponding to instruction addresses for substantially all instances of the common code segment in the dump information.

17. A system, comprising:
a processor;
a machine accessible medium responsive to the processor; and
instructions in the machine accessible medium, wherein the instructions, when executed by the processor, perform operations comprising:
obtaining performance data for software that has executed in a data processing system, wherein the performance data comprises instruction addresses and corresponding performance information;
obtaining dump information from the data processing system, wherein the dump information comprises the instructions and corresponding instruction addresses;
automatically identifying common code segments in the dump information, wherein a common code segment comprises an ordered set of multiple instructions that appears multiple times in the dump information; and
generating aggregate performance data for the common code segments, based at least in part on the instruction addresses associated with the common code segments from the dump information, the instruction addresses from the performance data, and the corresponding performance information from the performance data.

18. A system according to claim 17, wherein:
the operation of obtaining performance data comprises obtaining performance data for instructions generated by a dynamic compiler; and
the operation of generating aggregate performance data for the common code segments comprises generating aggregate performance data for common code segment generated by the dynamic compiler.

19. A system according to claim 17, wherein the operation of identifying common code segments in the dump information comprises:
selecting a candidate code segment from the dump information;
determining whether the candidate code segment occurs multiple times in the dump information; and
identifying the candidate code segment as a common code segment in response to determining that the candidate code segment occurs multiple times in the dump information.

20. A system according to claim 17, wherein:
the operation of identifying common code segments in the dump information comprises identifying at least first and second common code segments; and
the operation of generating aggregate performance data for the common code segments comprises:
collecting performance data for multiple instances of the first common code segment;
generating aggregate performance data for the first common code segment, based at least in part on the performance data for the multiple instances of the first common code segment;
collecting performance data for multiple instances of the second common code segment; and
generating aggregate performance data for the second common code segment, based at least in part on the performance data for the multiple instances of the second common code segment.
